(19) United States
(12) Patent Application Publication
(10) Pub. No.: US 2023/0244853 A1
(43) Pub. Date: Aug. 3, 2023

(54) METHOD, SYSTEM, AND COMPUTER DEVICE FOR GENERATING PORTAL PAGES

(71) Applicant: Hefei Hantai Network Science Technology Co., Ltd, Hefei (CN)

(72) Inventor: Yegan Qian, Hefei (CN)

(73) Assignee: Hefei Hantai Network Science Technology Co., Ltd, Hefei (CN)

(21) Appl. No.: 18/297,619

(22) Filed: Apr. 9, 2023

(30) Foreign Application Priority Data
Aug. 9, 2022 (CN) 202210949027 .X

(51) Int. Cl. G06F 40/149; G06F 16/958; G06F 8/35

(52) U.S. Cl. CPC G06F 40/149; G06F 16/986; G06F 8/35

(57) ABSTRACT

A method, system and computer device for generating portal pages, including: registering all portal component systems to a portal system portlet library, enabling the portal system to obtain portal portlets from the portlet library, creating a portal page through the portal system, configuring the required portlet system for a new portal page from the portal portlet library, and save name information, page ID identity information and configured portal portlet system information of the portal page into a database; at the same time, the portal system will transfer the newly created portal page information to an IFrame HTML tag contained in the portal system's main page. The IFrame will present the newly created page and load the configured portlets, realizes the partial refresh of a single page of the portal system SPA, save server resources and broadband resources, improve page response speed, and obtain a better user experience.

### CROSS-REFERENCE TO RELATED APPLICATION

The present application claims priority to the Chinese patent application NO. 202210949027.X filed in the State Intellectual Property Office of the P.R.C. on Aug. 9, 2022, which is incorporated herein by reference in its entirety.

### TECHNICAL FIELD

The present invention relates to portal technology, in particular, to a method, system, and computer device for generating portal pages.

### BACKGROUND OF THE INVENTION

The Chinese invention patent application with the application publication number CN 110989987A and publication date Apr. 10, 2020 from the applicant Beijing Xiaomi Mobile Software Co., Ltd. discloses a generation method, device, client, server, and storage medium for a portal webpage. The patent states the following background technology:

Portal web page is a comprehensive web page used to display various kinds of information. In related technologies, a web page is usually developed as a project, and resources are mostly concentrated in the same server. Therefore, the loading of the existing portal web page is based on the centralized loading from the server. As a special web page, the portal web page gathers all kinds of information. If the traditional development and loading methods are followed, It is bound to cause the information of portal pages to be relatively fixed. If it is necessary to replace some types of information, it will inevitably lead to problems such as low development efficiency and high development cost, which will lead to low dynamic performance of portal pages.

The China authorized invention patent with the publication number of CN1979476A and the publication date of Jun. 13, 2007 from the applicant International Business Machines Corporation discloses the method and system for providing asynchronous portal pages, which is used to solve the problem of generating asynchronous portal pages by the portlet system developed on the basis of a traditional WEB technology, namely a programming model based on synchronous refresh technology. The solution is mainly to use the portal server to modify the WEB content of the portal portlets to redirect HTTP requests to XMLHTTP requests. Because of the large number of portal portlets, this way of modifying the web content of portal portlets to redirect to XMLHTTP is difficult to avoid manual inspection and modification, which also makes the modification workload complex and huge, even unbearable.

The aforementioned Chinese invention application from Beijing Xiaomi Mobile Software Co., Ltd. with the publication number of CN110989987A needs to save the portal portlet to the client in its solution. Obviously, the traditional portlets developed based on the programming model of synchronous refresh technology or their back-end program code are portlets written based on Java, C # and other non-script languages, which cannot be saved to the client and run by the Web browser. Therefore, the disclosed solution is difficult to solve the generation of portal pages of traditional portlets developed based on the programming model of synchronous refresh technology and portlets written in non-script languages.

In the current software application development, Java, C # and other languages are generally used to write the application code of the back-end program. Therefore, in the development of the portlet system, C # or JAVA programming language is still the mainstream. How to efficiently generate the portlet system in the portal page is still a problem for developers.

### SUMMARY OF THE INVENTION

In order to solve the above problems, the present invention discloses a method, system, and computer device for generating portal pages, which effectively solves the problems of generating portal pages and integrating portal portlet systems.

In order to achieve the above purpose, the invention adopts the following technical scheme:

In one aspect of the invention, a method for generating a portal page is provided, including:

Firstly, all portal component systems are registered into a library, so that the portal system could obtain portal portlets from the portlet library and manage portal portlets, After logging in, the administrator creates a new portal page through the portal system, configures the required portal portlet system for the new portal page from the portal portlets library, and saves the portal page name information, page ID identity information, and configured portal portlet system information to the database. At the same time, the portal system transmits the newly created portal page information to the IFrame HTML tag contained in the portal system main page. Then the IFrame tag presents the newly created page and loads the configured portal portlets on the newly created page.

In addition, according to the above method of generating a portal page, the following additional technical features can also be provided:

The portal system comprises a portal portlet system developed based on a programming model of synchronous refresh technology;

The portal system includes a portal portlet system developed based on Java or C # and other non-script languages.

Preferably, after common users log in to the portal page, they can close a portal portlet system of a page according to their personal needs, or reopen the closed portal portlet of the page, personalize the presentation of the portlets system of the portal page, and the portal system loads the portal portlet system required by users in the generated portal page according to the new personalized settings.

Preferably, after common users log in to the portal page, they can set the layout mode of the portal portlet system on the page based on their personal needs. They can set a single column display mode or multiple column display mode. The portal system automatically displays the portal portlet system on the generated portal page based on the layout mode.

According to another aspect of the invention, a portal page generation system is provided, including:

The portal portlet registration management module uniformly manages the registration of portlets into the portlet library and portlet removal from portlets library of the portal system;

The portal page creation module sets the name information and page ID identity information of the portal page, configures the portal portlet system information required by the portal page from the portal portlet library, and saves it into the database;

The portal page presentation module receives the portal page information transmitted by the portal system, calls the IFrame HTML tag contained in the main page, renders the portal page in the IFrame frame tag, and loads the configured portal portlet system for the portal page.

In the above technical solution, preferably, the portal page presentation module also includes a portal portlet system management module:

The portal portlet system management module includes that ordinary users can manage the portal portlet system of the page according to their personal needs, including closing a portlet of the page, or reopening a portal portlet system that has been closed on the page, personalizing the presentation of the portlet system of the portal page, and loading the portal portlet system required by the user on the portal page according to the user's personalized settings.

Preferably, the portal page presentation module also includes: Set the layout of the portal component system on the page. You can set the single-column display or multi-column display mode. According to the display mode, the portal portlet system is automatically arranged and displayed on the generated portal page.

Preferably, the portal components of the portal system include:

The portal portlet system developed based on the programming model of synchronous refresh technology;

The portal portlet system includes a portal component system developed based on Java or C # and other non-script languages.

In another aspect of the present invention, a computer device is proposed, which includes a memory, a processor and a computer program stored in the memory and can be run on the processor. The processor is used to execute the steps of any method in the above technical solution.

The invention has the following beneficial effects: Through the IFrame internal frame tag in HTML, the generation of portal pages and the loading of component systems are realized, and the local refresh of the portal system's main page is realized, the server resources and broadband resources are saved, the page response speed is improved, and a better user experience is obtained; The internal framework of IFrame realizes the effect of local refresh, and at the same time, the portal system does not need to modify the WEB content of the portal components one by one to achieve the effect of redirecting HTTP requests to XMLHTTP requests to achieve local refresh; There are no uniformly requirements for the technical architecture of the portal portlet system. The portal portlet system includes the portal portlet system developed based on the synchronous refresh technology programming model, or the portal component system developed based on Java or C # and other non-script languages at the back end. The portal portlet is low coupled with the portal system, and the development of the portal portlet system is independent of the portal system; Users can personalize the portal portlet system contained in the portal page according to their own needs, and personalize the portlet layout of the portal page.

### BRIEF DESCRIPTION OF THE DRAWINGS

For better explanation of the technical solutions of the embodiments of the invention, the following is a brief description of the drawings needed to describe the embodiments. It is obvious that the drawings described below are only embodiments of the invention, and for those skilled in the art, other drawings can be obtained from these drawings without creative work. The invention can also be implemented in other ways different from those described herein. Therefore, the scope of protection of the invention is not limited by the specific embodiments disclosed below.

FIG. 1 is a flowchart illustrating a method for generating a portal page according to an embodiment of the present invention;

FIG. 2 is a schematic diagram of a portal page generation system provided by an embodiment of the invention;

FIG. 3 is a schematic diagram of a computer device provided by an embodiment of the invention.

### DETAILED DESCRIPTION OF EMBODIMENTS

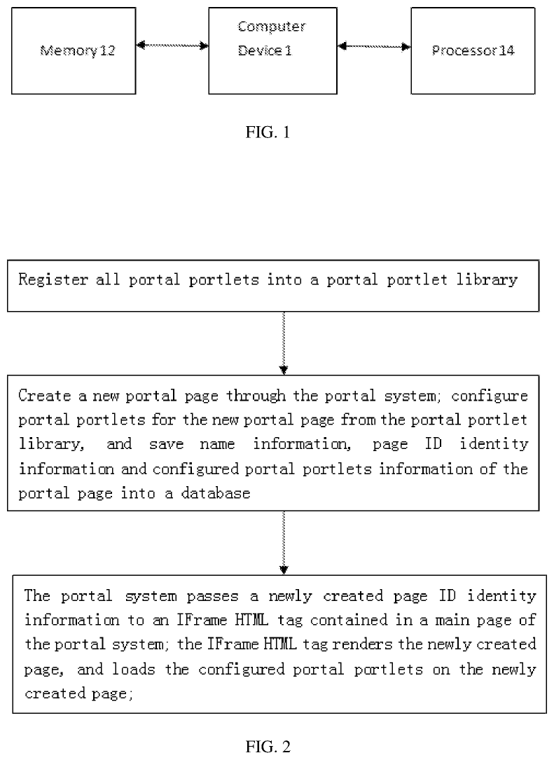

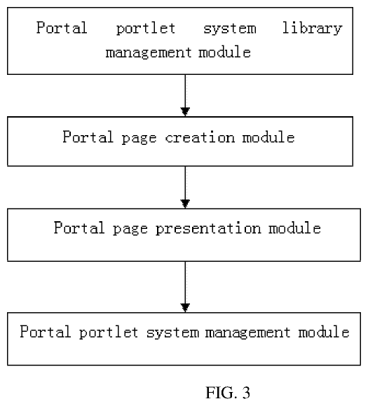

The embodiments of the invention are described in detail below in combination with the attached drawings. FIG. 1 and FIG. 2 show the flow diagram of the method for generating a portal page and the flow diagram of a system for generating a portal page, and FIG. 3 shows a computer device diagram of the preferred embodiment of the invention.

Now refer to FIG. 1, which shows the flow diagram of the generation method of the portal page of the preferred embodiment of the invention.

First, register all developed portal portlets into the portal portlets system library, which stores the portal portlets and the portal portlets name ID and other related information. The portal system obtains the portal portlets information from the portlets library and manages the portal portlets system; After logging into the portal system, the administrator creates a new portal page through the portal system page creation tool, configures the required portal portlets system for the new portal page from the portal system portlets library, and saves the name information of the portal page, page ID identity information, and configured portal portlets system information into the database; The portal system passes the newly created portal page information to the IFrame inner frame HTML tag contained in the main page of the portal system. The IFrame inner frame tag renders the newly created page, and loads the configured portal portlets system on the newly created page.

The technical features of the IFrame HTML tag can not only achieve the effect of local refresh, but also make the portal system unnecessary to modify the WEB content of the portal portlets one by one, so as to achieve the effect of redirecting HTTP requests to XMLHTTP requests to achieve local refresh.

The portal system adopts the SPA single page application, and the main page is the single page. The width, height and margin of the IFrame tag set on the main page make the IFrame occupy most of the space of the main page, 85% for the PC side, and 100% for the mobile phone side. It is able to dynamically adjust the layout of the portal page. The refresh of the portlet system does not cause a postback of the main page, and realizes partial refresh.

IFrame can access the CSS, Javascript and other parent page file resources in the parent page through the parent page to share the parent page resources; For the independent style sheet and script file of the independently developed portlet system, the parent page of the style sheet and script file can be completely kept undisturbed.

When the portal portlet is no longer used by the portal system, it will be removed from the portal portlet library. When the portal portlet needs to be updated, the updated portal portlet outside the portal system will replace the original portlet in the portal portlet library. The newly developed portal portlet system can be managed and used by the portal system after being registered through the portlet library.

There are no uniform requirements for the technical architecture of the portal portlet system, including the portal portlet system developed based on the synchronous refresh technology programming model, or its back-end is the portal portlet system developed based on Java or C # and other non-script languages.

After ordinary users log in to a portal page, they can close a portal portlet system of the page according to their personal needs, or reopen the closed portal portlet system of the page, personalize the presentation of the portlet system of the portal page, and the portal system loads the portal portlet system required by users in the generated portal page according to the new personalized settings;

After ordinary users login to the portal page, they can set the layout of the portal portlet system on the page according to their personal needs, and set a single-column display mode of each row or multi-column display mode of each row or three columns per row. The portal system automatically arranges and displays the portal portlet system on the generated portal page according to the display mode.

FIG. 2 shows a schematic diagram of a portal page generation system provided by an embodiment of the invention, including: portal portlet system library management module, portal page creation module, portal page presentation module, and portal portlet system management module;

Among them, the portal portlet system library management module is used to uniformly manage the registration of portlets into portlet library and removal of portlets from portlet library of the portal system; The portal page creation module sets the name information and page ID identity information of the portal page, configures the portal portlet system information required by the portal page from the portal portlet library, and saves it into a database; The portal page presentation module receives the portal page information transmitted by the portal system. The portal page is dynamically generated, and there is no actual corresponding page URL in the portal system file directory. It calls the IFrame HTML tag contained in the main page, renders the portal page in the IFrame tag, and loads the configured portal portlet system for the portal page; The portal portlet system management module includes that ordinary users can manage the page portal portlet system according to their personal needs, including closing a certain portal portlet of the page, or reopening a closed portal portlet system of the page, personalizing the presentation of the portlet system of the portal page, and loading the required portal portlet system on the portal page according to the user's personalized settings.

The portal page presentation module also includes setting the layout of the portal portlet system on the page, setting the single-column display or multi-column display mode, and automatically displaying the portal portlet system on the generated portal page according to the display mode.

The portal portlet system includes: the portal portlet system developed based on the programming model of synchronous refresh technology; or the portal portlet system based on JAVA and JSP page technology at the back end and XMLHTTP at the front end to achieve partial refresh; or a portal portlet system based on C # and ASPX page technology at the back end and XMLHTTP at the front end to achieve partial refresh.

FIG. 3 shows a schematic diagram of a computer device provided by the embodiment of the invention. The computer device 1 includes a memory 12, a processor 14 and a computer program stored on the memory 12 and can be run on the processor 14. The processor 14 is used to execute the steps of any method in the above embodiments.

According to the computer device 1 of the present invention, the processor 14 contained therein is used to execute the steps of the method for generating a portal page in the above embodiment, to execute modules of a system for generating a portal page in the above embodiment, so the computer device 1 can realize all the beneficial effects of the method, system, and computer device for generating portal pages.

According to the present invention, the computer device 1 contains a readable storage medium on which a computer program is stored. When the computer program is executed by the processor, the steps of any method in the above technical solution are implemented.

According to the computer-readable storage medium of the present invention, when the computer program stored on it is executed by the processor, the steps of the method for generating a portal page in the above embodiment are realized, the modules of the system for generating a portal page in the above embodiment are realized, so the computer-readable storage medium can realize all the beneficial effects of the method for generating the portal page.

The above is a preferred embodiment of the invention, and is not intended to limit the scope of protection of the invention.

What is claimed is:

1. A method for generating portal pages, comprising:
(1) registering all portal portlets of a portal system in a portal portlet library first, enabling the portal system to obtain portal portlet information from the portal portlet library and managing the portal portlet system;
(2) creating a new portal page through the portal system dynamically and virtually, configuring required portal portlets for the new portal page from the portal portlet library, saving name information, page ID identity information and configured portal portlets information of the new portal page into a database;
(3) passing the new portal page ID identity information to an IFrame HTML tag contained in a main page of the portal system; rendering the new portal page through the IFrame HTML tag, and loading the configured portal portlets on the new portal page;
(4) there is no physical corresponding page URL in the portal system file directory for the new portal page.

2. The method of claim 1, further comprising: developing a portal portlet based on the programming model of synchronous refresh technology.

3. The method of claim 1, further comprising: developing a portal portlet system based on a non-script language such as Java or C #.

4. The method of claim 1, further comprising: closing the portal portlet system of the portal page according to personal needs; reopening the closed portal portlet system of the portal page; personalizing the presentation of the portle system of the portal page; loading the portal portles in the generated portal page according to the new personalized settings.

5. The method of claim 1, further comprising: after logining the portal page, setting a layout of the portal portlet system on the portal page according to personal needs, setting a single-column display mode of each row or multi-column display mode of each row or three columns per row; displaying the portal portlet system on the generated portal page according to display mode.

6. A system for generating portal pages, comprising: portal portlet system library management module, portal page creation module, portal page presentation module, portal portlet system management module;
wherein the portal portlet system library management module uniformly manages registration of portlets into a portlet library and removal of portlets from the portlet library of a portal system;
wherein the portal page creation module sets name information and page ID identity information of a portal page, configures portal portlet system information required by the portal page from the portal portlet system library, and saves it into a database;
wherein the portal page presentation module receives the portal page information transmitted by the portal system; the portal page is dynamically generated, and there is no actual corresponding page URL in the portal system file directory, the portal system calls an IFrame HTML tag contained in a main page, renders the portal page in the IFrame tag, and loads configured portal portlets for the portal page;
wherein the portal page is dynamically and virtually generated, and there is no actual corresponding page URL in the portal system file directory.

7. The system of claim 6, further comprising: said portal portlet system management module manage portal portlet system according to personal needs, comprising:
closing a certain portal portlet of the portal page, reopening a closed portal portlet system of the portal page;
personalizing the presentation of the portlet system of the portal page;
loading the required portal portlet system on the portal page according to personalized settings.

8. The system of claim 6, further comprising: the portal page presentation module including setting layout of the portal portlet system on the portal page via single-column display mode or multi-column display mode; according to the display mode, the portal portlet system is automatically arranged and displayed on the portal page.

9. The system of claim 6, further comprising: developing the portal portlet system based on a programming model of synchronous refresh technology;

10. A computer device, including a memory, a processor and a computer program stored on the memory and operable on the processor, characterized in that the processor is used to perform the steps of the method described in any one of claims 1 to 5.
